(19) United States
(12) Patent Application Publication
(10) Pub. No.: US 2003/0147129 A1
(43) Pub. Date: Aug. 7, 2003

(54) Device for enlarging and exposure of digital exposure data on light-sensitive photo paper

(76) Inventor: Helmut Gohner, Lage (DE)

Correspondence Address: Mitchell P. Novick, Esq., Law Offices of Mitchell P. Novick, 66 Park Street, Montclair, NJ, 07042, US

(21) Appl. No.: 09/765,760

(22) Filed: Jan. 19, 2001

(30) Foreign Application Priority Data
Jan. 19, 2000 (DE) 200 00 906.0

(51) Int. Cl. G02B 21/36

(52) U.S. Cl. 359/363

(57) ABSTRACT

A device for enlarging and exposure of digital exposure data, i.e., from a PC or a digital camera, onto light-sensitive photo paper comprising a lamp with reflector, a light mixer, an LCD-chip arranged between two polarization filters, and an enlargement optic, wherein the enlargement optic comprises a commonly used enlargement objective and a correction lens means, arranged between the LCD-chip and the enlargement objective, and the correction lens means is laid out in such a way that the rays escaping from the LCD-chip are evenly and centrically guided into the enlargement objective.

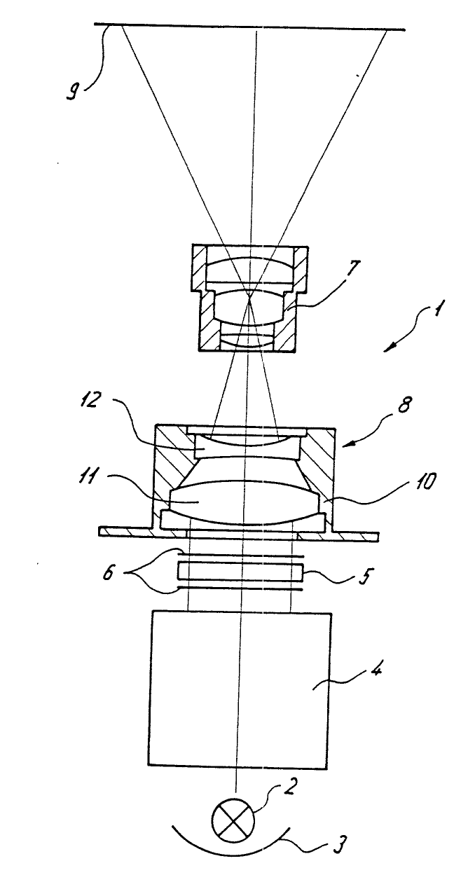

The invention under consideration concerns a device for the enlargement and exposure of digital exposure data, i.e., of a PC or a digital camera, on light-sensitive photo paper, including a lamp with reflector, a light mixer, an LCD-chip arranged between two polarization filters, and an enlargement optic.

Devices of this type are actually well known.

On the basis of the peculiarities of the LCD-chips which are used in such devices (the escaping light, in contrast to an illuminated negative, does not run evenly in the direction of the optical axis), for the achievement of pictures that are even and exposed without an appreciable decrease in light, thus far specialized objectives, so-called telecentric objectives, have to be used, which in comparison to enlargement objectives common in the trade are extremely expensive.

The basic challenge for this invention is to create a device of the customary type whose enlargement optic is relatively low-priced and which specifically accommodates its use in every standard-exposure apparatus, i.e., a printer or an enlarger.

The solution of this task lies in the fact that the enlargement optic consists of a customary enlargement objective and a correction lens or a correction lens system arranged between the LCD-chip and the enlargement objective, whereby the correction lens or the correction lens system is arranged in such a way that the light rays escaping from the LCD-chip will be fed into the enlargement objective evenly and centrically.

Therefore, the enlargement optic of the invented device consists of two optical parts, i.e., on the one hand, a common enlargement objective which is present with standard exposure meters, printers or enlargers, and a correction lens which can be produced relatively cheaply, or a correction lens system which can be produced relatively cheaply—and on the basis of the equalized light guidance through the correction lens or the correction lens system, it facilitates optimal results in the enlargement of digital exposure data in the manner specified.

The costs for the purchase of a correction lens or of a correction lens system, in addition to the common enlargement objective (which is on hand anyway) are much lower than the costs for the purchase of a specially manufactured, telecentric objective which was needed up until now for purposes of this kind.

The results attainable with the invented device are in no way inferior to the results with telecentric objectives—provided, of course, that an optically high-quality enlargement objective is used.

An example for application of the invention is shown in the attached drawing, aid described in more detail below.

The only FIGURE shows a schematically illustrated cut through an invention-like device.

In the drawing, a Device for the Enlargement and Exposure of digital Exposure data whose main parts consist of a Lamp 2 with a Reflector 3, Light mixer 4, an LCD-chip 5 arranged between two polarization filters 6, as well as an Enlargement optic yet to be described, is marked with the reference sign 1.

According to the invention, the enlargement optic consists of a commonly used enlargement objective 7, as well as a correction lens or correction lens system 8, arranged between the LCD-chip and the enlargement objectives.

The correction lens or the correction lens system 8 is laid out in such a way that the light rays escaping from the LCD-chip 5 are fed evenly and centrically into the enlargement objective. Above the enlargement objective 7, a light-sensitive photo paper 9 is then exposed in the usual fashion.

For the equalization of the feeding of light, it is recommended to keep the distance between the correction lens or the correction lens system 8 and the LCD-chip 5 as short as possible. If necessary, the LCD-chip 5 with its two polarization filters 6 might even be installed directly at the mounting 10 of the correction lens or the correction lens system 8.

The drawing shows a correction lens system 8, which includes two lenses 11 and 12. Here, lens 11 is developed as convex lens, and lens 12 as diverging lens.

I claim:

1. A device for enlarging and exposure of digital exposure data, i.e., from a PC or a digital camera, onto light-sensitive photo paper comprising a lamp with reflector, a light mixer, an LCD-chip arranged between two polarization filters, and an enlargement optic, wherein the enlargement optic comprises a commonly used enlargement objective and a correction lens means, arranged between the LCD-chip and the enlargement objective, and the correction lens means is laid out in such a way that the rays escaping from the LCD-chip are evenly and centrically guided into the enlargement objective.

2. The device in accordance with claim 1, wherein the distance between the correction lens means and the LCD-chip is very short.

3. The device in accordance with claim 1, wherein the LCD-chip is fastened directly at the mounting of the correction lens means.

4. The device in accordance with claim 1, wherein the correction lens means comprises a first lens and a second lens, whereby the first lens is developed as a convex lens and the second lens is developed as a diverging lens.
